(19) United States
(12) Patent Application Publication
(10) Pub. No.: US 2003/0023526 A1
(43) Pub. Date: Jan. 30, 2003

(54) Financial securities and valuations for pharmaceutical research and development

(76) Inventor: Jeffrey Joseph Stewart, Spokane, WA (US)

Correspondence Address: Jeffrey J. Stewart, 2205 E 17th, Spokane, WA, 99203, US

(21) Appl. No.: 09/917,381

(22) Filed: Jul. 27, 2001

(51) Int. Cl. G06F 17/60

(52) U.S. Cl. 705/35

(57) ABSTRACT

Described is a financial debt security for the raising of capital for pharmaceutical R&D. Also described is a method of estimating the value of such a debt security. Also described is a method of estimating the value of a pharmaceutical in research and development.

### BACKGROUND OF THE INVENTION

This invention relates to a financial security for raising capital for a risk- and time-dependent endeavor such as a pharmaceutical research and development (R&D) project.

Pharmaceutical R&D

R&D of pharmaceuticals takes many years and millions of dollars. Pharmaceutical R&D typically is divided into six phases: preclinical, phase 1 clinical trial, phase 2 clinical trial, phase 3 clinical trial, approval, and revenue.

In the preclinical phase, expenses are highly variable and average about $250,000 per year per research PhD employed. About 1 in 10 preclinical research projects yield a marketed pharmaceutical. The preclinical phase averages about 6 years (Pharmaceutical Research and Manufacturers of America. The pharmaceutical industry profile 2000; Moschco, Nat Biotech 18:719, 2000).

In the United States, following the preclinical phase, a pharmaceutical firm selects a pharmaceutical for a series of clinical trials (generally three) and additional animal studies supporting these clinical trials. Each of these clinical trial phases is associated with risks that are increasingly mitigated as the pharmaceutical successfully progresses through the clinical trial phases (Pharmaceutical Research and Manufacturers of America. The pharmaceutical industry profile 2000; Moschco, Nat Biotech 18:719, 2000). Clinical trials are performed to satisfy regulatory bodies (the FDA in the U.S.) that the pharmaceutical is both safe and effective. Each phase is also associated with expenses and time. The three phases are:

Phase 1: Generally 20-80 (i.e., an average of about 50) healthy subjects are administered the pharmaceutical to determine human toxicity and the maximum safe dose. Phase 1 generally takes 6-12 months (i.e., an average of about 9 months). Costs run from $8,000-15,000+ per subject (i.e., an average total phase 1 expense of about $575,000). Animal studies are required to support phase 1. These studies cost on average about $500,000. The historical risk mitigated (i.e., the likelihood of reaching the market eventually) upon entering phase 1 is about 20%. That is, only one in five pharmaceuticals that are tested in a phase 1 trial is eventually licensed for sale in the U.S.

Phase 2: Generally 100-300 (i.e., an average of about 200) patients are tested to determine the most effective dose and/or the efficacy of the pharmaceutical. Phase 2 trials generally last about 1.5 years. Costs run from $8,000-15,000+ per subject (i.e., an average total expense of about $2,300,000 for a phase 2 trial). Animal studies are required to support phase 2. These animal studies cost on average about $1,000,000. The historical risk mitigated (i.e., the likelihood of reaching the market eventually) upon entering phase 2 is about 30%.

Phase 3: Generally 1,000-5,000+ (i.e., an average of about 3,000) patients are tested to confirm the efficacy of the pharmaceutical and to detect human toxicity related to long-term administration. Phase 3 trials generally last about 3.5 years. Per patient expenses are generally about half that of earlier phases because each patient is monitored infrequently relative to patients in phase 1 or 2 trials (i.e., an average total expense of about $17,250,000 to complete a phase 3 trial). Animal studies are required to support phase 3. These studies cost on average about $1,500,000. The historical risk mitigated (i.e., the likelihood of reaching the market eventually) upon entering phase 3 is about 67%.

After a pharmaceutical has successfully progressed through all three clinical trial phases, the sponsoring pharmaceutical or biotech firm then files for regulatory approval (with the FDA for product registration in the U.S.) during an approval phase. Costs associated with preparing the documentation for FDA approval (for the filing of a new drug application (NDA), an abbreviated NDA (ANDA), or a biologics licensing application (BLA)) depend largely on the quantity and the quality of data to be presented. Typical NDA expenses run from $500,000-$1,500,000+. Pharmaceutical companies filing NDAs usually pay the FDA the Prescription Drug User Fee Act II fee (which runs just over $300,000) in order to speed up review of their FDA registration request. The overall average expense associated with FDA registration is about $1,300,000. FDA registration averages 1.5 years. Under the Prescription Drug User Fee Act, the risk mitigated (i.e., the likelihood of approval) upon submitting an NDA is 80-85% (i.e., and average risk mitigated of about 83%).

Finally, the pharmaceutical is registered (approved) by the FDA for marketing in the U.S., and the pharmaceutical or biotech company may market its pharmaceutical to the U.S. public in a revenue phase. The length of the revenue phase depends on several factors, especially remaining blocking patent life and competition (U.S. Congress, Office of Technology Assessment. Pharmaceutical R&D: costs, risks and rewards, OTA-H-522. Washington, D.C.: U.S. Government Printing Office. February 1993). A revenue phase of 10 years is expected on average.

Pharmaceuticals often are not manufactured and marketed by biotech firms. Rather, current practice has biotech firms partnering with large pharmaceutical companies and thus outsourcing manufacturing and marketing. The general costs of outsourcing manufacturing and marketing to a large pharmaceutical company run to about 60% of gross sales (Moschco, Nat Biotech 18:719, 2000).

Debt Funding

Evaluation of the ability (and desire) to repay debt forms the basis for issuing debt (see, for example, Barnhill et al., High Yield Bonds. McGraw Hill, New York City, 1999). Key parameters in such evaluations are the cash flow of a company (for corporate debt) or the value of assets (for securitized debt) . Based on these and other parameters, debt issuance in the form of bonds are rated “AAA” (highest rating) through “D ” (default). Bonds are used to raise capital for many endeavors, including house purchases, municipal construction projects such as the building of schools, and corporate development. However, current methodologies of evaluating the ability and desire to repay debt are generally not applicable to risk- and time-dependent endeavors such as pharmaceutical R&D. Pharmaceutical R&D firms often have a negative cash flow because they do not generate significant revenue for some time. Furthermore, the value of the IP held by such firms has not heretofore been rationally estimable. These two factors combine to prevent widespread issuance of securitized bonds in high-risk sectors such as pharmaceutical R&D. Thus, there exists a need for new forms of securitized debt to capitalize the R&D of biotech and pharmaceutical firms.

Valuation Prior Art

A reasonable estimate of the value of an asset is one of the keys to securing debt. Unfortunately, there is currently no reasonable methodology for estimating the value of highly risky endeavors such a pharmaceutical in R&D phases. In illustration of this fact, a survey of CEOs and business developers from the pharmaceutical and biotechnology industries reported that over 10% of these executive admit to using a “best guess” in assigning value to their own intellectual property (IP; Moschco, Nat Biotech 18:719, 2000).

The inability to assign accurate value to pharmaceutical IP assets has led directly to the under-capitalization of pharmaceutical and biotech companies and to inefficient merger and acquisition processes. Biotech firms are generally unable to acquire debt funding until these firms generate cash flow or are already highly capitalized. Furthermore, companies purchasing or selling R&D-stage pharmaceuticals tend to appraise incorrectly the value of the IP until cash flows are established. If biotech companies partner with manufacturing and marketing companies (generally large pharmaceutical companies), these partners must agree in advance of product sales what royalty is fairly due each party, and this royalty pricing depends on valuing fairly the IP. Finally, investors are unable to assign fair values for their investments in pharmaceutical and biotech firms because the value of the underlying assets—the pharmaceutical R&D projects in development—is unrecognized.

Several approaches have been taken to valuing pharmaceutical and biotech IP. All of these methods harbor serious flaws that undermine the utility of these methods.

For example, 21% of high-level pharmaceutical executives use a “cost plus” approach to valuation (Moschco, Nat Biotech 18:719, 2000). That is, these executives add an arbitrary margin onto anticipated expenses. This method obviously ignores the risks inherent to pharmaceutical R&D and also ignores the fact that pharmaceuticals with lower costs may be sold at higher margins.

Another way to value IP is to assess companies whose chief asset is IP and determine what such a “pure play” company sells for. The flaw of this approach is that these “pure play” companies may not have priced their own IP fairly, and even if they did so, they likely were in a disadvantageous financial position when they were acquired, and so the IP is undervalued by such a methodology. By analogy, such a methodology would value real estate by surveying the selling prices attained at foreclosure auctions. The inadequacy of such a method is obvious.

Another methodology is to value IP as a call option valued according to the Black-Scholes equation (F. Black, and M. Scholes. J Pol Econ, 81: 637, 1973) or similar equations. The Black-Scholes equation assumes the current value of the IP has already been set fairly by the market, and thus such a methodology is incapable of setting current value for IP when the market has not priced the IP in the first place (as is the case for pharmaceuticals in R&D phases).

Yet another methodology is to use discounted cash flow analysis with a high discount rate (e.g., 15% in the year before anticipated product approval and an additional 5% for each additional year remaining until product approval) to account for business and technology risks. The discount rate is arbitrary, and so such methods set arbitrary value to IP.

The current lack of accurate, reliable, and communicable valuation methodologies leaves no rational basis for investment. Thus, there remains a desperate need for new and rational valuation methodologies for pharmaceutical R&D projects and the IP assets that underpin these projects.

Risk Management

Examples are found in the prior art of methods and apparatuses to manage risk. These prior art patents include U.S. Pat. No. 4,739,478, which is directed to methods and apparatus for restructuring debt obligations; U.S. Pat. No. 4,751,640, which is directed to an automated investment system; U.S. Pat. Nos. 4,752,877, 4,722,055, and 4,839,804, which are directed to methods and apparatuses for funding future liability of uncertain cost; U.S. Pat. No. 6,134,536, which is directed to methods and apparatus relating to the formulation and trading of risk management contracts; and U.S. Pat. No. 5,812,988, which is directed to a method and system for jointly estimating cash flows, simulated returns, risk measures and present values for a plurality of assets. None of these prior art disclosures allows rational pricing of a risk and time-dependent endeavor such as a pharmaceutical in R&D phases.

Other related publications in the field of risk-managed investment include: Fama, Eugene F. and Kenneth R. French, 1993, Common Risk Factors in the Returns on Stocks and Bonds, Journal of Financial Economics 33, 3-56; Lintner, John, 1965, The Valuation of Risk Assets and the Selection of Risky Investments in Stock Portfolios and Capital Budgets, Review of Economics and Statistics 47, 13-37; and Sharpe, William F., 1964, Capital Asset Prices: A Theory of Market Equilibrium under Conditions of Risk, Journal of Finance 19, 425-442.

### SUMMARY OF THE INVENTION

An object of the present invention is to provide a novel financial security for the financing of pharmaceutical R&D. The financial security comprises a debt issued at time 0 on a pharmaceutical R&D cash flow and further comprises a face (par) value, at least one default term, an interest rate, at least one repayment term, and a discount price, where the discount price D is calculated in accordance with the equation D=R₀F (described in detail in the “DEBT SECURITY” section).

Another object of the present invention is to estimate the value of a pharmaceutical cash flow while the pharmaceutical is in R&D phases.

The present method of estimating the value of a pharmaceutical R&D cash flow is plainly described as the present value of each expense or income times the likelihood of having to pay the expense or receiving the income. This method comprises calculating V₀ in accordance with the equation

$${V}_{0} = {\sum }_{y = 0}^{n} ( \frac{{I}_{y} {R}_{0}}{{{R}_{y} ( 1 + k )}^{y}} - \frac{{E}_{y} {R}_{0}}{{{R}_{y} ( 1 + k )}^{y}} ) ,$$

which is described in detail in the “ESTIMATING VALUE” section).

Another object of the present invention is to assign value to debt raised to capitalize pharmaceutical R&D and whose repayment depends on reaching a revenue phase. In plain terms, the value of a debt is the present value of the face (par) value of the debt times the current risk mitigated. The method comprises calculating V₀ in accordance with the equation

V₀=R₀F(1+q−w)^{y}

(described in detail in the “VALUING DEBT” section).

### DETAILED DESCRIPTION OF THE INVENTION

Definitions

By “pharmaceutical,” it is meant any composition, formulation, or method for improving the health of a human or a non-human animal, with the further proviso that sale to the public of such a pharmaceutical is under the jurisdiction of at least one governmental regulatory body including, but not limited to, the U.S. FDA and the European Medicines Evaluation Agency (EMEA).

By “pharmaceutical cash flow,” “cash flow of a pharmaceutical,” “pharmaceutical R&D cash flow,” and the like, it is meant the totality of the income due at certain times as a result of ownership in or license to a pharmaceutical and the remaining expenses to be paid at certain times by the developer of that pharmaceutical to develop that pharmaceutical. For purposes of clarity, an illustrative example of a pharmaceutical cash flow is as follows: an annual expense of $1,000,000 for years 0-2 to pay for phase 1 and phase 2 trials and associated animal studies, an annual expense of $7,000,000 for years 3-6 to pay for a phase 3 trial and associated animal studies, an expense of $2,000,000 in year seven for expenses associated with filing an NDA with the FDA, annual expenses of $400,000,000 for years 8-17 for manufacturing and marketing the pharmaceutical, and an annual income of $1,000,000,000 in gross product sales for years 8-17.

By “R&D pharmaceutical,” “pharmaceutical R&D,” and the like, it is meant a pharmaceutical where at least one of the following conditions is met: 1) A pharmaceutical that is not sold legally to the public as a treatment for a diseased condition. 2) A pharmaceutical that is not registered (approved) for sale to the public by at least one governmental regulatory body in at least one jurisdiction of that body; these regulatory bodies include, but are not limited to, the U.S. FDA and the EMEA. 3) A pharmaceutical that is registered (approved) for sale to the public for the treatment of at least one diseased condition but not for all diseased conditions believed to be treatable by the pharmaceutical, approval being granted by at least one governmental regulatory body in at least one jurisdiction of that body.

By “present value,” it is meant the value today (time y=0) of an income or expense received or paid at a current or future time. For a constant discount (interest) rate, present value of an income is given by the equation

_{PV}I=I/(1+k)^{y},

where _{PV}I is the present value of an income, where I is the income, where k is the discount (interest) rate, and where the income is received at time y. Similarly, for a constant discount (interest) rate, the present value of an expense is given by the equation

_{PV}E=E/(1+k)^{y},

where _{PV}E is the present value of an expense, where E is the expense, where k is the discount (interest) rate for each time period, and where the expense is paid at time y.

By “net present value,” it is meant the value today (time period 0) of a net cash flow (income minus expense) received or paid at a future time. For a constant discount (interest) rate, net present value of a cash flow is given by the equation

_{NPV}C=[I/(1+k)^{y}]−[E/(1+k)^{y}],

where _{NPV}C is the net present value of a cash flow, where I is the income, where E is the expense, where k is the discount (interest) rate for each time period, and where the net cash flow is received or paid at time y.

By “risk-adjusted net present value,” it is meant the value when time, risk, and projected income, and projected expenses are all taken into account.

By “risk mitigated,” at a time in R&D, it is meant the likelihood that the endeavor will progress to a revenue phase. Thus, an endeavor with 10% risk mitigated would have only a 1 in 10 chance of reaching a revenue phase.

By “face value,” it is meant the principal of a debt upon which interest is calculated. The face value is also called the “par value.” Thus, a debt with a face value of $100, an annual interest (coupon) rate of 10%, and that is due in one year from issuance would pay $110 at the end of that year. The face value often is not the price paid to the issuer of the debt. Instead, debt can be sold at a premium (higher than face value) or, more commonly, at discount (lower than face value).

By “risk-free interest rate,” it is meant an interest rate that may be earned through investment whose default risk does not significantly differ from the default risk of the United States of America.

By “discount price,” it is meant a price less than the face value of a debt paid to acquire a debt security.

By “securitized debt,” it is meant a debt where a default on the debt would allow a contractual seizure of one or more assets of the debt issuer.

By “intellectual property,” it is meant any non-tangible asset that can be transferred to another party. Intellectual property includes, but is not limited to, patents, patent applications, trade secrets, trademarks, designs, data, and license to the same.

Debt Security

An object of the present invention is to provide a novel financial security (in a preferred embodiment, a securitized bond) for the financing of a risk- and time-dependent endeavor. In particular, such a financial security is needed to raise capital for pharmaceutical R&D. Accordingly, an object of the present invention is to provide a financial security that facilitates the selling of debt to finance pharmaceutical R&D.

The financial security comprises a debt issued at time 0 on a pharmaceutical R&D cash flow and further comprises a face value, at least one default term, an interest rate, at least one repayment term, and a discount price, where the discount price D is calculated in accordance with the equation

D=R₀F,

where R₀ is the risk mitigated at time 0 (when the debt is issued), and where F is the face value.

It will be obvious to those with ordinary skill in the art that the interest rate may be a constant (as in a fixed rate note) or may be variable (as in a floating rate note such as a prime floating-rate note or a Prime/LIBOR spread note).

In a preferred embodiment, the debt is securitized by intellectual property that, but for license to the intellectual property, the making, using, or selling of the pharmaceutical would infringe upon at least one valid claim of the intellectual property. That is, whatever intellectual property is required to carry out the projected pharmaceutical R&D and that is owned by the debt issuer represents an asset that, in a preferred embodiment, provides default security to the debt holder.

In an alternative embodiment, the debt is securitized by assets other than intellectual property. Such assets include, but are not limited to, laboratory equipment, proprietary cell lines, research assays, transgenic animals, proteins, protein crystals, antibodies, nucleic acids, viruses, and laboratory reagents.

In a preferred embodiment, when the pharmaceutical is at a preclinical phase of development, R₀ is set at about 10%.

In a preferred embodiment, when the pharmaceutical is at a phase 1 clinical trial phase of development, R₀ is set at about 20%.

In a preferred embodiment, when the pharmaceutical is at a phase 2 clinical trial phase of development, R₀ is set at about 30%.

In a preferred embodiment, when the pharmaceutical is at a phase 3 clinical trial phase of development, R⁰ is set at about 67%.

In a preferred embodiment, when the pharmaceutical is at an approval phase of development, R₀ is set at about 83%.

The main advantage of equity over debt is that equity can reach a higher value than debt. In contrast, debt has a capped upside. In order to sell debt, the issuer sometimes includes warrants (equity call options) concurrently with the debt or offers the debt holder the option to exchange (convert) some or all issued debt for a portion of company equity at a contractually predetermined ratio or price. Debt tradable for equity (or any other commodity, such as a precious metal, or for any other security, such as a U.S. Treasury bond) is termed “convertible debt.” Accordingly, in an alternative embodiment of the present financial security invention, at least a portion of the debt is convertible debt that may be exchanged, at the discretion of the debt holder, at predetermined terms for a commodity or security.

There are two primary reasons to set strict, performance-based default terms. First, such terms ensure that the managers of the pharmaceutical R&D reach a revenue phase in a timely manner. Second, when the debt is securitized (especially by IP), such terms allows the debt holder to seize and liquidate assets in a timely manner (a key consideration because patents are perishable goods). Therefore, a preferred embodiment of the present financial security invention further comprises at least one default term that would declare a default when management fails to perform. Preferred default terms include, but are not limited to, a failure to pay a scheduled debt repayment, a failure to begin a phase 1 clinical trial by a predetermined time, a failure to begin a phase 2 clinical trial by a predetermined time, a failure to begin a phase 3 clinical trial by a predetermined time, a failure to file an NDA with the U.S. FDA by a predetermined time, a failure to file an ANDA with the U.S. FDA by a predetermined time, a failure to file a BLA with the U.S. FDA by a predetermined time, a failure to be granted regulatory registration (approval) by a predetermined time, a failure to be granted U.S. FDA registration (approval) by a predetermined time, a failure to be granted EMEA regulatory registration (approval) by a predetermined time, a failure to enter into a contract with a third party by a predetermined time, and the failure to meet a contractual obligation with a third party.

Not every scientifically reasonable pharmaceutical R&D project makes rational financial sense. In some cases, the risks and expenses are not justified by projected income. Before the financial security of the present invention is purchased, it is anticipated that the debt issuer should be projected to be able to repay the debt if the pharmaceutical reaches a revenue stage. Methods of projecting the income of a developer of a pharmaceutical R&D project are well known to those with skill in the art (see, for example, Moschco, Nat Biotech 18:719, 2000). Accordingly, in a preferred embodiment of the present financial security invention, the ability to repay the debt at the repayment term or terms is estimated from projected net cash flow of that pharmaceutical of its revenue phase. By definition, risk of reaching the revenue phase is not completely mitigated until the revenue phase.

In an alternative embodiment of the present invention, the financial security is offered with a revised interest rate of 0%. If the financial security is a bond, then such a bond is termed a “zero-coupon bond.” It will be obvious to those having ordinary skill in the art that a debt with a face value, an interest rate greater than zero, and a repayment schedule may be alternatively and substantially equivalently expressed as a debt with a higher face value and no interest rate. That is, the repayment when the debt is due (principal+accrued interest) can be held to be the revised face value of the debt, and the revised interest rate is then held to be 0%. A debt repayment (P) is normally calculated according to the equation P=F(1+k)^{y}, where F is the face value of the debt, where k is the interest rate, and where y is the time the debt is due to be repaid. This same debt could be expressed as a “zero-coupon” debt by defining a revised face value (F′) that is the debt repayment (F′=P) and that is held to have a revised interest rate (k′) set at 0%. The revised face value (F′) is

F′=F(1+k)^{y}

with k being the underlying but hidden interest rate (k′ never enters the equation). For a zero-coupon debt, the discount (D) price of the debt is properly calculated in accordance with the equation

D=R₀F

and not by

D=R₀F′.

For the discount price (D) to be calculated in accordance with the revised face value (F′) of the debt, D is calculated in accordance with the equation

D=R₀F′/(1+k)^{y},

where k (and not k′ set at 0%) is the underlying but hidden interest rate.

It will be obvious to those with ordinary skill in the art that repayment of the debt need not be a single, lump sum payment but rather be amortized over numerous payments. For example, payments may be made to offset the interest so that only the face value is repaid at the maturity date. Methods of interconverting lump sum payments and amortized payments are very well known to those with ordinary skill in the art.

Estimating Value

Another object of the present invention is to estimate the value of a risk- and time-dependent endeavor with a utility not heretofore attainable by any method described in the prior art. While the method of the present invention may have utility in estimating the value of many such endeavors, the method of the present invention is most applicable to estimating the value of a pharmaceutical cash flow while the pharmaceutical is in R&D phases.

The present method of estimating the value of a pharmaceutical R&D cash flow is plainly described as the present value of any expense or income times the likelihood of having to pay that expense or receiving that the income.

In formal terms, the method of estimating the value at time 0 of a pharmaceutical R&D cash flow comprises calculating V₀ in accordance with the equation:

$${V}_{0} = {\sum }_{y = 0}^{n} ( \frac{{I}_{y} {R}_{0}}{{{R}_{y} ( 1 + k )}^{y}} - \frac{{E}_{y} {R}_{0}}{{{R}_{y} ( 1 + k )}^{y}} ) ,$$

where V₀ is the value at time 0, where y is the time, where I_{y} is the income received at time y, where R₀ is the risk mitigated at time 0, where R_{y} is the risk mitigated at time y, where k is the discount rate, where E_{y} is the expense paid at time y, and where n is the time of the last income or expense.

It will be obvious to those with ordinary skill in the art that a varying discount rate could be applied.

If time 0 is the present, then V₀ is the risk-adjusted net present value of a pharmaceutical R&D cash flow.

There are numerous possible sources of income during pharmaceutical R&D. The most important is generally the pharmaceutical royalty income earned from gross sales. Income includes, but is not limited to, investments, milestone payments, royalty income, pharmaceutical royalty income, licensing fees, sales revenue, orphan drug tax credits (ODTCs), tax credits, grants, revenue generated by debt issuance, and revenue generated by equity sales. By way of explanation, ODTCs are tax credits returned to the developer of a pharmaceutical that can treat only a limited number of patients (<200,000) in the U.S.; ODTCs are half of clinical-trial costs.

There are numerous possible expenses that may be incurred during pharmaceutical R&D. Expenses include, but are not limited to, investments, milestone payments, royalty payments, pharmaceutical royalty payments, debt payments regulatory approval expenses, licensing fees, clinical trial expenses, animal study expenses, research expenses, manufacturing expenses, marketing expenses, overhead expenses, taxes, and development expenses.

The discount rate k may be set at what is termed “risk-free interest rate” (i.e., the interest rate attainable without appreciable risk). In reality, there is no risk-free investment, and the risk-free costs of capital is generally equated to the current interest rate paid on the 30-year U.S. treasury bond, which is taken to have a negligible default risk. Another choice for k is the opportunity cost of the lending institution. That is, a venture capital firm may have an annual internal rate of return (IRR) of 20%, in which case an annual 20% return is the “baseline” expected by that venture capital firm. In another example, the IRR of a pharmaceutical company may be 15%, and thus an annual k of 15% could be assumed given that the capital could have been invested in other projects earning 15% interest annually. There are many other methodologies for selecting an appropriate discount rate that also include many other factors such as management risk and competition risk. It is intended that a user of the method of the present invention select a discount rate k the user determines to be most appropriate for the pharmaceutical R&D project in question.

It is important that k be the discount rate of the appropriate time period (this will be obvious to those with ordinary skill in the art). The time period in the series y=(0→n) is the incremental integer value of y. Thus, if k represents an annual discount rate, then each integer y is properly a year (thus, if the present year is y=0, the first year following the present year is y=1, and the last year of analysis—the nth year—is y=n). Similarly, if k represents a monthly discount rate, then each integer y would properly represent a month. Methods of converting discount rates among annual discount rates, semi-annual discount rates, monthly discount rates, weekly discount rates, daily discount rates, and discount rates for other time periods are very well known to those with ordinary skill in the art.

It is anticipated that users of the present invention will select predicted expenses, mitigated risks, and completion times for each pharmaceutical R&D phase that are relevant for the pharmaceutical being analyzed. Such selections are necessarily subjective and require expertise in the field; therefore, it is an object of the present invention to provide guidance to the user of the valuation method of the present invention. The user is directed, in the absence of information or skill to the contrary, to use average industry values for the predicted expenses, risk mitigated, and times to complete each pharmaceutical R&D phase (these values are outlined in greater detail in the “PHARMACEUTICAL R&D” section, above).

The average expenses (E_{y}) include, but are not limited to: a phase 1 clinical trial expense of about $575,000, a phase 2 clinical trial expense of about $2,300,000, a phase 3 clinical trial expense of about $17,250,000, an animal study expense in support of a phase 1 clinical trial of about $500,000, an animal study expense in support of a phase 2 clinical trial of about $1,000,000, an animal study expense in support of a phase 3 clinical trial of about $1,500,000, and an FDA approval-associated expense of about $1,300,000.

The average risk mitigated (R_{y}) includes, but is not limited to: about 10% for a preclinical phase, about 20% for a phase 1 clinical trial phase, about 30% for a phase 2 clinical trial phase, about 67% for a phase 3 clinical trial phase, and about 83% for an approval phase. Once the revenue phase is reached, risk of reaching the revenue phase is completely mitigated, and thus R_{y} is 100%.

The average time of pharmaceutical R&D phase includes, but is not limited to, about 6 years for a preclinical phase, about 9 months for a phase 1 clinical trial, about 1.5 years for a phase 2 clinical trial, about 3.5 years for a phase 3 clinical trial, about 1.5 years for an approval phase, and about 10 years for a revenue phase.

Valuing Debt

Another object of the present invention is to provide a method of estimating the value of a debt whose repayment will depend on successfully reaching a revenue phase. In particular, an object of the present invention is to assign value to debt raised to capitalize pharmaceutical R&D and whose repayment depends on reaching a revenue phase. It will be appreciated by those with skill in the art that no such valuation method is obvious given that such a debt instrument has not heretofore been described.

In general terms, the value of a debt is the present value of the face value of the debt times the current risk mitigated.

In a preferred embodiment, the present value is calculated with an effective interest rate (k) that is the difference between the risk-free interest rate and the interest rate of the debt.

In formal terms, the preferred embodiment of the method of estimating the value of a debt, at time 0, of a debt issued on a pharmaceutical R&D cash flow comprises calculating V₀ in accordance with the equation:

V₀=R₀F(1+q−w),

where R₀ is the risk mitigated at time 0, F is the face value of the debt, q is the interest rate of the debt, w is the risk-free interest rate, y is the time the debt is due to be repaid, and R₀F is the discount price.

In a preferred embodiment, w is the current interest rate on a U.S. treasury bond.

In a preferred embodiment, the U.S. Treasury bond used to define w is the 30-year U.S. Treasury bond.

Closing

All publications including, but not limited to, patents and patent applications cited in this specification are herein incorporated by reference as if each individual publication were specifically and individually indicated to be incorporated by reference herein as though fully set forth.

It will be appreciated by those having ordinary skill in the art that the equations presented here may be alternatively expressed in a trivial manner (e.g., by rearranging terms, by performing an irrelevant or insignificant function on both sides of an equation, or by introducing an irrelevant or insignificant parameter such as by adding the price of pork bellies in Burkina Faso) and that such alternative expressions of the equations are substantially equivalent to the equations presented here.

The foregoing descriptions of the preferred embodiments of the invention have been presented for the purposes of illustration and description. They are not intended to be exhaustive or to limit the invention to the precise forms disclosed. Many modifications and variations are possible in the light of the above teachings. It is intended that the scope of the invention be limited not by the detailed description but rather by the claims appended hereto. The following non-limiting examples are provided to illustrate further the present invention.

### EXAMPLE 1

Given

The pharmaceutical tiamatophen has successfully completed a phase 3 clinical trial. What would be a fair selling price for the tiamatophen R&D project?

The current likelihood of earning approval is estimated to be average for an approval phase (R₀=83%). The appropriate discount rate is 15% (k=15%). Time 0 is the present time.

FDA approval is estimated to take one year (y=0). Approval costs (E₀) are estimated to run to $1,300,000. The risk mediated is estimated at about average at the approval phase (R₀=83%)

Analysis of the market indicates that an annual royalty of $400,000,000 can be anticipated to the owner of tiamatophen for a 15-year revenue phase (I_{y}=$400,000,000 for y=(1→15) and where R_{y}=100%) . n=15.

Analysis

The risk-adjusted net present value (V₀) of tiamatophen is calculated according to the equation

$${V}_{0} = {\sum }_{y = 0}^{n} ( \frac{{I}_{y} {R}_{0}}{{{R}_{y} ( 1 + k )}^{y}} - \frac{{E}_{y} {R}_{0}}{{{R}_{y} ( 1 + k )}^{y}} )$$

to be $1,940,026,872.75. A fair selling price for tiamatophen would be almost $2,000,000,000.00.

### EXAMPLE 2

Given

The pharmaceutical ormuzdicaine has successfully completed a phase 2 clinical trial. Does the ormuzdicaine R&D project justify the $500,000,000 price paid by a large pharmaceutical company to acquire ormuzdicaine?

The current likelihood of earning approval is estimated to be average for a phase 3 clinical trial (R₀=67%). The appropriate discount rate is 15% (k=15%). Time 0 is the present time.

Phase 3 is estimated to take three years (y=(0→2)). Annual phase 3 costs are estimated to be $6,000,000 (E_{y}=$6,000,000 for y=(0→2)). Phase 3 risk mediated is average (R_{y}=67% for y=(0→2)).

FDA approval is estimated to take one year (y=3). Approval costs are estimated to run to $1,300,000 (E₃=$1,300,000). The risk mediated is estimated at about average at the approval phase (R₃=83%).

Analysis of the market indicates that an annual royalty of $100,000,000 can be anticipated to the owner of ormuzdicaine for a 10-year revenue phase (I_{y}=$100,000,000 for y=(4→13) and where R_{y}=100%). n=13.

Analysis

The risk-adjusted net present value (V₀) of ormuzdicaine is calculated according to the equation

$${V}_{0} = {\sum }_{y = 0}^{n} ( \frac{{I}_{y} {R}_{0}}{{{R}_{y} ( 1 + k )}^{y}} - \frac{{E}_{y} {R}_{0}}{{{R}_{y} ( 1 + k )}^{y}} )$$

to be $204,650,513.91. The pharmaceutical company that paid $500,000,000 for ormuzdicaine overpaid by about $300,000,000.

### EXAMPLE 3

Given

The pharmaceutical thothivir has successfully completed a phase 1 clinical trial. Does it make rational financial sense to continue the thothivir R&D project?

The current likelihood of earning approval is estimated to be 40% (R₀=40%). The appropriate discount rate is 15% (k=15%). Time 0 is the present time.

Phase 2 is estimated to take two years (y=(0→1)). Annual phase 2 costs are estimated to be $1,600,000 (E_{y}=$1,600,000 for y=(0→1)). Phase 2 risk mediated is estimated to be somewhat above average because thothivir performed well in an uncontrolled pilot study (R_{y}=40% for y=(0→1).

Phase 3 is estimated to take three years (y=(2→4)). Annual phase 3 costs are estimated to be $8,000,000 (E_{y}=$8,000,000 for y=(2→4)). Phase 3 risk mediated is estimated to be average (R_{y}=67% for y=(2→4)).

FDA approval is estimated to take one year (y=5). Approval costs are estimated to run to $1,300,000 (E₅=$1,300,000). The risk mediated is estimated at about average at the approval phase (R₅=83%).

Analysis of the market indicates that an annual royalty of $1,000,000,000 can be anticipated to the owner of thothivir for an 8-year revenue phase (I_{y}=$1,000,000,000 for y=(6→13) and where R_{y}=100%) . n=13.

Analysis

The risk-adjusted net present value (V₀) of thothivir is calculated according to the equation

$${V}_{0} = {\sum }_{y = 0}^{n} ( \frac{{I}_{y} {R}_{0}}{{{R}_{y} ( 1 + k )}^{y}} - \frac{{E}_{y} {R}_{0}}{{{R}_{y} ( 1 + k )}^{y}} )$$

to be $879,611,384.16. Therefore, it does make rational sense to continue the thothivir R&D project.

### EXAMPLE 4

Given

The pharmaceutical tlalocor has successfully completed its preclinical phase and is ready to enter clinical trials. Does it make rational financial sense to continue the tlalocor R&D project?

The current likelihood of earning approval is estimated to be below average for a phase 1 clinical trial (R₀=13%) . The appropriate discount rate is 15% (k=15%). Time 0 is the present time.

Phase 1 is estimated to take one year (y=0). The phase 1 cost is estimated to be $1,000,000 (E₀=$1,000,000). Phase 1 risk mediated is estimated to be below average because of toxicity associated with long-term use of a tlalocor analog (R₀=13%).

Phase 2 is estimated to take two years (y=(1→2)). Annual phase 2 costs are estimated to be $1,500,000 (E_{y}=$1,500,000 for y=(1→2)). Phase 2 risk mediated is estimated to be below average because of toxicity associated with long-term use of a tlalocor analog (R_{y}=20% for y=(1→2)).

Phase 3 is estimated to take four years (y=(3→6)). Annual phase 3 costs are estimated to be $5,000,000 (E_{y}=$5,000,000 for y=(3→6)). Phase 3 risk mediated is estimated to be below average because of toxicity associated with long-term use of a tlalocor analog (R_{y}=45% for y=(3→6)). FDA approval is estimated to take two years (y=(7→8)). Annual approval costs are estimated to run to $1,000,000 (E_{y}=$1,000,000 for y=(7→8)). FDA approval will not be sought unless tlalocor does not exhibit the toxicity associated with its analog. Therefore, the risk mediated is estimated at about average for the approval phase (R_{y}=83% for y=(7→8)).

Analysis of the market indicates that an annual royalty of $25,000,000 can be anticipated to the owner of tlalocor for a 9-year revenue phase (I_{y}=$25,000,000 for y=(9→17) and where R_{y}=100%) . n=17.

Analysis

The risk-adjusted net present value (V₀) of tlalocor is calculated according to the equation

$${V}_{0} = {\sum }_{y = 0}^{n} ( \frac{{I}_{y} {R}_{0}}{{{R}_{y} ( 1 + k )}^{y}} - \frac{{E}_{y} {R}_{0}}{{{R}_{y} ( 1 + k )}^{y}} )$$

to be a negative $743,900.63. Hence, it does not make rational financial sense to continue the tlalocor project.

### EXAMPLE 5

Given

The pharmaceutical heimdalitrin is in its preclinical phase. What is the risk-adjusted net present value of heimdalitrin?

The current likelihood of earning approval is estimated to below average for a preclinical phase because the preclinical phase has just begun (R₀=5%). The appropriate discount rate is 15% (k=15%). Time 0 is the present time.

The preclinical phase is estimated to take 6 years (y=0→5). The annual preclinical cost is estimated to be $500,000 (E_{y}=$500,000 for y=(0→5)). Risk mitigated is estimated to be 5% for the first two years, 10% for the next two years, and 15% for the final two years of preclinical R&D (R₀=R₁=5%, R₂=R₃=10%, R₄=R₅=15%).

Phase 1 is estimated to take one year (y=6). The phase 1 cost is estimated to be $1,000,000 (E₆=$1,000,000). Phase 1 risk mediated is estimated to be average (R₆=20%).

Phase 2 is estimated to take two years (y=(7→8)). Annual phase 2 costs are estimated to be $1,500,000 (E_{y}=$1,500,000 for y=(7→8)) Phase 2 risk mediated is estimated to be average (R_{y}=30% for y=(7→8)).

Phase 3 is estimated to take 3 years (y=(9→11)). Annual phase 3 costs are estimated to be $7,000,000 (E_{y}=$7,000,000 for y=(9→11)). Phase 3 risk mediated is estimated to be average (R_{y}=67% for y=(9→11)).

FDA approval is estimated to take 1 year (y=12). Annual approval costs are estimated to run to $1,300,000 (E₁₂=$1,300,000) Risk mediated is estimated at about average at the approval phase (R₁₂=83%).

Analysis of the market indicates that an annual royalty of $250,000,000 can be anticipated to the owner of heimdalitrin for an 8-year revenue phase (I_{y}=$250,000,000 for y=(13→20) and where R_{y}=100%) n=20.

Analysis

The risk-adjusted net present value (V₀) of heimdalitrin is calculated according to the equation

$${V}_{0} = {\sum }_{y = 0}^{n} ( \frac{{I}_{y} {R}_{0}}{{{R}_{y} ( 1 + k )}^{y}} - \frac{{E}_{y} {R}_{0}}{{{R}_{y} ( 1 + k )}^{y}} )$$

to be $91,705,233.93.

### EXAMPLE 6

Given

The pharmaceutical sivaprin has successfully completed a phase 3 clinical trial. Debt has been issued to capitalize the approval phase. What is the debt issuance worth?

The current risk mediated is average for an approval phase (R₀=83%). The face value is $5,000,000 (F=$5,000,000). The interest rate is 15% (q=15%). The risk-free interest rate is 5% (w=5%). The debt is due to be repaid at the end of the 3rd year (y=3). Time 0 is the time the debt is issued.

Analysis

The value (V₀) of the debt issued on sivaprin is calculated according to the equation

V₀=R₀F(1+q−w)^{y}

to be worth $5,523,650.00.

### EXAMPLE 7

Given

The pharmaceutical apsuvatin has successfully completed a phase 2 clinical trial. Debt has been issued to capitalize the phase 3 clinical trial. What is the debt issuance worth?

The current risk mediated is average for a phase 3 clinical trial (R₀=67%). The face value is $30,000,000 (F=$30,000,000). The interest rate is 20% (q=20%). The risk-free interest rate is 5.5% (w=5.5%). The debt is due to be repaid at the end of the 8th year (y=8). Time 0 is the time the debt is issued.

Analysis

The value (V₀) of the debt issued on apsuvatin is calculated according to the equation

V₀=R₀F(1+k)^{y}

to be worth $59,379,966.85.

### EXAMPLE 8

Given

The pharmaceutical tyraal has successfully completed a phase 1 clinical trial. Debt has been issued to capitalize the phase 2 clinical trial. What is the debt issuance worth?

The current risk mediated is average for a phase 2 clinical trial (R₀=30%). The face value is $10,000,000 (F=$10,000,000). The interest rate is 20% (q=20%). The risk-free interest rate is 6% (w=6%). The debt is due to be repaid at the end of the 10th year (y=10). Time 0 is the time the debt is issued.

Analysis

The value (V₀) of the debt issued on tyraal is calculated according to the equation

V₀=R₀F(1+q−w)^{y}

to be worth $11,121,663.94.

### EXAMPLE 9

Given

The pharmaceutical enlil has successfully completed its preclinical phase and is ready to enter a phase 1 clinical trial. Debt has been issued to capitalize the phase 1 clinical trial. What is the debt issuance worth?

The current risk mediated is average for a phase 1 clinical trial (R₀=20%). The face value is $5,000,000 (F=$5,000,000). The interest rate is 14% (q=14%). The risk-free interest rate is 5.8% (w=5.8%). The debt is due to be repaid at the end of the 10th year (y=10). Time 0 is the time the debt is issued.

Analysis

The value (V₀) of the debt issued on enlil is calculated according to the equation

V₀=R₀F(1+q−w)^{y}

to be worth $3,522,868.48.

### EXAMPLE 10

Given

The pharmaceutical peleosil is in a preclinical phase. Debt has been issued to capitalize the remaining preclinical phase R&D. What is the debt issuance worth?

The current risk mediated is average for a preclinical phase (R₀=10%). The face value is $12,000,000 (F=$12,000,000). The interest rate is 21% (q=21%). The risk-free interest rate is 5.1% (w=5.1%). The debt is due to be repaid at the end of the 15th year (y=15). Time 0 is the time the debt is issued.

Analysis

The value (V₀) of the debt issued on peleosil is calculated according to the equation

V₀=R₀F(1+q−w)^{y}

to be worth $10,975,714.09.

### EXAMPLE 11

A bond is issued on the pharmaceutical R&D of the pharmaceutical enkidusamet, which has successfully completed a phase 3 clinical trial.

Time zero is the present time.

The face value of the bond is $4,000,000 (F=$4,000,000).

The default terms declare default if a scheduled debt repayment is missed or if FDA approval has not been granted for enkidusamet marketing to the U.S. public by the beginning of year 3.

Repayment terms are that the entire debt is due at the beginning of year 5.

The interest (coupon) rate of the bond is 14%.

The risk mediated at the time of debt issuance is average for an approval phase (R₀=83%).

The discount price of the enkidusamet bond is calculated in accordance with the equation D=R₀F to be $3,320,000.00.

### EXAMPLE 12

A securitized bond is issued on the pharmaceutical R&D of the pharmaceutical muginate HCl , which has successfully completed a phase 2 clinical trial.

Time zero is the present time.

The face value of the bond is $35,000,000 (F=$35,000,000).

The IP that allows R&D and eventual marketing of muginate HCl comprises 7 issued U.S. patents, 2 PCT filings, 3 pending U.S. patents, and 120,000 pages of unpublished clinical-trial data.

The default terms declare default if any one of the following conditions is not met: the entire debt is repaid at the beginning of year 10, FDA approval has been granted for muginate HCl marketing to the U.S. public by the beginning of year 7, and muginate HCl is entered into a phase 3 clinical trial by the beginning of year 2. If default is declared, the debt issuer is required to transfer the aforementioned IP to the debt holder for liquidation.

Repayment terms are that the entire debt is due at the beginning of year 10.

The interest (coupon) rate of the bond is 17%.

The risk mediated at the time of debt issuance is average for a phase 3 clinical trial (R₀=67%).

The discount price of the muginate HCl bond is calculated in accordance with the equation D=R₀F to be $23,450,000.00.

### EXAMPLE 13

A securitized convertible debt is issued by Gita, Inc., on the pharmaceutical R&D of its pharmaceutical, arjunase, which has successfully completed a phase 1 clinical trial.

Time zero is the present time.

The face value of the debt is $10,000,000 (F=$10,000,000).

The IP that allows R&D and eventual marketing of arjunase comprises 4 issued U.S. patents, 30,000 pages of unpublished clinical-trial data, and trademark to the name “Bhagavase” (the anticipated trade name of arjunase).

The default terms declare default if any one of the following conditions is not met: every scheduled debt repayment is made, FDA approval has been granted for arjunase marketing to the U.S. public by the beginning of year 10, arjunase has entered into a phase 3 clinical trial by the beginning of year 5, arjunase has entered into a phase 2 clinical trial by the beginning of year 1 (the end of the current year), and an FDA-approved good manufacturing practice plant is built or acquired by Gita, Inc., by the end of year 8. If default is declared, the debt issuer is required to transfer the aforementioned IP to the debt holder for liquidation.

Repayment terms call for repayment of the debt with annual payments of $2,000,000 beginning in year 15 and continuing until the entire debt is repaid.

The interest rate of the debt is 12.5%.

The risk mediated at the time of debt issuance is average for a phase 2 clinical trial (R₀=30%).

If no default has been declared by year 10, then up to 75% of convertible debt may be converted into shares of Gita, Inc., at a ratio of $1 of the arjunase debt's face value for 1 share of Gita, Inc., common stock.

The discount price of the arjunase debt is calculated in accordance with the equation D=R₀F to be $3,000,000.00.

### EXAMPLE 14

A securitized bond is issued on the pharmaceutical R&D of dagonotrexate, which has successfully completed preclinical testing and is ready to enter a phase 1 clinical trial.

Time zero is the present time.

The face value of the bond is $7,000,000 (F=$7,000,000).

The IP that allows R&D and eventual marketing of dagonotrexate comprises 1 issued and 1 pending U.S. patent.

The default terms declare default if any one of the following conditions is not met: every scheduled debt repayment is made, FDA approval has been granted for dagonotrexate marketing to the U.S. public by the beginning of year 15, an NDA for dagonotrexate is filed with the U.S. FDA by the beginning of year 12, dagonotrexate enters into a phase 3 clinical trial by the beginning of year 6, dagonotrexate enters into a phase 2 clinical trial by the beginning of year 3, and dagonotrexate enters into a phase 1 clinical trial by the beginning of year 1 (the end of the current year). If default is declared, the debt issuer is required to transfer the aforementioned IP to the debt holder for liquidation.

Repayment terms are that the entire debt is due at the beginning of year 20.

The interest (coupon) rate of the bond is 15%.

The risk mediated at the time of debt issuance is average for a phase 1 clinical trial (R₀=20%).

The discount price of the dagonotrexate bond is calculated in accordance with the equation D=R₀F to be $1,400,000.00.

### EXAMPLE 15

A bond is issued on the pharmaceutical R&D of molochirate, which is in its preclinical phase. If molochirate reaches the market, an annual net profit of $500,000,000 is anticipated.

Time zero is the present time.

The face value of the bond is $20,000,000 (F=$20,000,000).

The default terms declare default if any one of the following conditions is not met: every scheduled debt repayment is made, FDA approval has been granted for molochirate's marketing to the U.S. public by the beginning of year 17, an NDA for molochirate is filed with the U.S. FDA by the beginning of year 15, molochirate enters into a phase 3 clinical trial by the beginning of year 11, molochirate enters into a phase 2 clinical trial by the beginning of year 8, and molochirate enters into a phase 1 clinical trial by the beginning of year 6.

Repayment terms are that the entire debt is due at the beginning of year 20.

The interest (coupon) rate of the bond is 15%.

The risk mediated at the time of debt issuance is average for a preclinical phase (R₀=10%).

The discount price of the molochirate bond is calculated in accordance with the equation D=R₀F to be $2,000,000.00.

The ability to repay the debt at the beginning of year 20, assuming no prior default, is estimated by comparing the projected molochirate profits projected to be accrued by the beginning of year 20. If there has been no default, then FDA approval must have been granted at least by the beginning of year 17. Thus, at least three years of the revenue phase will have accrued by the time the debt is due. At $500,000,000/year, the projected profits will be $1,500,000,000. The repayment due (P_{y}) when y=20 is calculated according to the equation

P_{y}=F(1+k)^{y}=$327,330,747.86.

The repayment due is significantly less than the minimum projected revenue in the absence of prior default. Repayment is 22% of anticipated minimum profits (if there is no prior default), so the company issuing the molochirate bond is taken to be able to repay the debt if molochirate is approved. In fact, more debt probably could have been raised on molochirate than was issued.

I claim:

1. A method of estimating the value at time 0 of a pharmaceutical R&D cash flow, said method comprising calculating V₀ in accordance with the equation:
$${V}_{0} = {\sum }_{y = 0}^{n} ( \frac{{I}_{y} {R}_{0}}{{{R}_{y} ( 1 + k )}^{y}} - \frac{{E}_{y} {R}_{0}}{{{R}_{y} ( 1 + k )}^{y}} ) ,$$
where V₀ is the value at time 0, where y is the time, where I_{y} is the income received at time y, where R₀ is the risk mitigated at time 0, where R_{y} is the risk mitigated at time y, where k is the discount rate, where E_{y} is the expense paid at time y, and where n is the time of the last income or expense.

2. The method of claim 1 where said time 0 is the present time and where V₀ is the risk-adjusted net present value of a pharmaceutical R&D cash flow.

3. The method of claim 1 where said income is selected from the group consisting of investments, milestone payments, royalty income, pharmaceutical royalty income, licensing fees, sales revenue, orphan drug tax credits, tax credits, grants, revenue generated by debt issuance, and revenue generated by equity sales.

4. The method of claim 1 where said expense is selected from the group consisting of investments, milestone payments, royalty payments, pharmaceutical royalty payments, debt payments regulatory approval expenses, licensing fees, clinical trial expenses, animal study expenses, research expenses, manufacturing expenses, marketing expenses, overhead expenses, taxes, and development expenses.

5. A method of claim 1 where k is the risk-free interest rate.

6. A method of claim 1 where at least one said expense, said risk, or the time of a pharmaceutical R&D phase is estimated to be about average.

7. A method of claim 6 where said average expense is selected from the group consisting of a phase 1 clinical trial expense of about $575,000, a phase 2 clinical trial expense of about $2,300,000, a phase 3 clinical trial expense of about $17,250,000, an animal study expense in support of a phase 1 clinical trial of about $500,000, an animal study expense in support of a phase 2 clinical trial of about $1,000,000, an animal study expense in support of a phase 3 clinical trial of about $1,500,000, and an approval-associated expense of about $1,300,000.

8. A method of claim 6 where said average risk R_{y} is selected from the group consisting of about 10% for a preclinical phase, about 20% for a phase 1 clinical trial phase, about 30% for a phase 2 clinical trial phase, about 67% for a phase 3 clinical trial phase, and about 83% for an approval phase.

9. A method of claim 6 where said average time of a pharmaceutical R&D phase is selected from the group consisting of about 6 years for a preclinical phase, about 9 months for a phase 1 clinical trial, about 1.5 years for a phase 2 clinical trial, about 3.5 years for a phase 3 clinical trial, about 1.5 years for an approval phase, and about 10 years for a revenue phase.

10. A method of estimating the value, at time 0, of a debt issued on a pharmaceutical R&D cash flow, said method comprising calculating VO in accordance with the equation:
V₀=R₀F(1+q−w)^{y},
where R₀ is the risk mitigated at time 0, F is the face value of said debt, q is interest rate of said debt, w is the risk-free interest rate, y is the time said debt is due to be repaid, and R₀F is the discount price.

11. A financial security comprising a debt issued at time 0 on a pharmaceutical R&D cash flow, said security comprising a face value, at least one default term, an interest rate, at least one repayment term, and a discount price, where said discount price D is calculated in accordance with the equation D=R₀F, where R₀ is the risk mitigated at time 0, and where F is said face value.

12. The security of claim 11 where said debt is securitized by intellectual property that, but for license to said intellectual property, the making, using, or selling of said pharmaceutical would infringe upon at least one valid claim of said intellectual property.

13. The security of claim 11 where said pharmaceutical is at a preclinical phase of development and where said R₀ is about 10%.

14. The security of claim 11 where said pharmaceutical is at a phase 1 clinical trial phase of development and where said R₀ is about 20%.

15. The security of claim 11 where said pharmaceutical is at a phase 2 clinical trial phase of development and where said R₀ is about 30%.

16. The security of claim 11 where said pharmaceutical is at a phase 3 clinical trial phase of development and where said R₀ is about 67%.

17. The security of claim 11 where said pharmaceutical is at an approval phase of development and where said R₀ is about 83%.

18. The security of claim 11 where at least a portion of said debt is convertible debt.

19. The security of claim 11 where said default term is selected from the group consisting of a failure to pay a scheduled debt repayment, a failure to begin a phase 1 clinical trial by a predetermined time, a failure to begin a phase 2 clinical trial by a predetermined time, a failure to begin a phase 3 clinical trial by a predetermined time, a failure to file an NDA with the U.S. FDA by a predetermined time, a failure to file an ANDA with the U.S. FDA by a predetermined time, a failure to file a BLA with the U.S. FDA by a predetermined time, a failure to be granted regulatory approval by a predetermined time, a failure to be granted U.S. FDA approval by a predetermined time, a failure to be granted EMEA approval by a predetermined time, a failure to enter into a contract with a third party by a predetermined time, and the failure to meet a contractual obligation with a third party.

20. The security of claim 11 where the ability to repay said debt at said repayment term is estimated from projected net cash flow of the revenue phase.
